(19) United States
(12) Patent Application Publication
(10) Pub. No.: US 2025/0264060 A1
(43) Pub. Date: Aug. 21, 2025

(54) GAS TURBINE MULTICOPTER POWERTRAIN AND FLIGHT CONTROL SYSTEM

(71) Applicant: JAMES THURMAN, MANSFIELD, TX (US)

(72) Inventor: JAMES THURMAN, MANSFIELD, TX (US)

(21) Appl. No.: 19/060,036

(22) Filed: Feb. 21, 2025

Related U.S. Application Data
(60) Provisional application No. 63/556,066, filed on Feb. 21, 2024.

(51) Int. Cl. F02C 9/20; B64U 50/12

(52) U.S. Cl. CPC F02C 9/20; B64U 50/12; F05D 2220/323

(57) ABSTRACT

A gas powered multicopter system includes engines that produce exhaust gas that is directed to a plurality of turbines for the operation of a plurality of rotors for the purpose of generating lift. The gas powered engine produces exhaust that is routed through an exhaust tube. The exhaust is directed through a flow combiner that is configured to regulate the downstream flow of exhaust. The exhaust is routed through a series of flow control valves each associated with a function or degree of freedom as governed by a control stick used by the pilot. The flow control valves selectively redirect the flow of exhaust gas to the plurality of turbines to adjust the flight characteristic of the multicopter.

### CROSS REFERENCE TO RELATED APPLICATIONS

This application claims the benefit of an earlier filing date and right of priority to U.S. Provisional Application No. 63/556,066, filed 21 Feb. 2024, the contents of which is incorporated by reference herein in its entirety.

### BACKGROUND OF THE INVENTION

### 1. Field of the Invention

The present application relates to a flight control system, and more particularly to a gas turbine multicopter powertrain and flight control system.

### 2. Description of Related Art

Multicopters are aircraft often thought of to be similar to helicopters but differ in that they utilize multiple rotors to control its flight. Multicopters have seen widespread usage but primarily on unmanned aircraft. One of the most common variants of multicopters are quadcopters. Quadcopters have 4 rotors/propellers, which is the minimum required for a multicopter. Traditionally, multicopters utilize direct drive electric motors to drive a minimum of 4 propeller/rotors on the aircraft. It is known there have also been some multicopters that utilize direct drive internal combustion engines and hybrid gas/electric.

An advantage for multicopters over conventional helicopters is primarily due to the simplicity of their flight control system. It allows for complete pitch, roll and yaw control through selective RPM control/throttling of the motors via direct drive to the rotors/propellers. In contrast, conventional helicopters require large complex rotor systems with cyclic and collective pitch change devices as well as constant RPM governors. They also typically require heavy, complex speed reduction gears and powertrains to support the low RPM main rotor as well as an anti-torque tail rotor.

A key benefit of the conventional helicopter, however, is the ability to autorotate to landing in the event of engine or tail rotor failure. Typical multicopters have no ability to autorotate in the event of a complete power loss. This is because blade pitch must be reduced to autorotate and typical multicopters have fixed pitch propellers/rotors. Additionally, in a quadcopter configuration, the loss of one engine is a catastrophic event since at least four motors/engines are required to balance torque for yaw control and maintain flight attitude.

Although electric motors are highly reliable, they are expensive and batteries have far less energy density than gasoline or jet/diesel fuel. When it comes to a manned quadcopter, failure of one motor/engine is an unacceptable risk. Such a failure would likely be unrecoverable due to the reaction time a pilot would need to respond and the lack of any autorotation capability. A typical solution is to utilize six to eight motors/engines as a failsafe, but this is problematic because it leads to smaller rotors/propellers which are less efficient in a hover. It also increases maintenance cost for each engine. This is especially problematic for a gas powered engine since overhaul will eventually be required on all engines. Lastly, training for flight with loss of an engine would be difficult and is not yet defined by the FAA.

Although strides have been made, shortcomings remain. It is desired that a gas turbine powertrain and flight control system be provided that transmits power from at least one motor/engine to a minimal amount of rotors/propellers via jet exhaust that is converted to rotational motion via turbines.

### BRIEF SUMMARY OF THE INVENTION

It is an object of the present application to provide a gas turbine multicopter powertrain and flight control system that allows for power to be transferred to multiple multicopter rotors/propellers from a single or multiple gas turbine engines. It is one object to have the power transferred via turbines connected to each rotor/propeller. These turbines extract power directly from the jet exhaust gases. Additionally, it also serves as the means for roll, pitch and yaw control. An ideal application for this system is for manned multicopters but could also be utilized for unmanned multicopters as well. A primary purpose is to provide a safe, reliable, simple, low cost, low maintenance and fail-safe powertrain/flight control system for multicopters.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a schematic of a gas turbine multicopter system according to an embodiment of the present application.

FIG. 2 is a chart of throttle controls for use with the system of FIG. 1.

FIG. 3 is a schematic of forward flow control valves and tubes in the system of FIG. 1.

FIG. 4 is a schematic of backward flow control valves and tubes in the system of FIG. 1.

FIG. 5 is a schematic of right roll flow control valves and tubes in the system of FIG. 1.

FIG. 6 is a schematic of left roll flow control valves and tubes in the system of FIG. 1.

FIG. 7 is a schematic of yaw right flow control valves and tubes in the system of FIG. 1.

FIG. 8 is a schematic of yaw left flow control valves and tubes in the system of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, a gas turbine powertrain and flight control system allows for a manned multicopter that transmits power from at least one motor/engine to a minimal amount of rotors/propellers via jet exhaust converted to rotational motion via turbines. In the event of engine failure, all rotors/propellers would lose power equally. This prevents catastrophic loss of attitude and yaw control.

In a dual engine configuration all rotors/propellers could be powered by the operating engine through the same Gas Turbine powertrain. In the event of complete power failure one benefit of the multicopter over the conventional helicopter is the ease of which a whole aircraft parachute can be implemented between the multicopter rotors/propellers. This Gas Turbine powertrain also allows for control of roll, pitch and yaw through simple flow control valves to the rotors/propellers. A Gas Turbine powertrain system has benefit over other typical powertrains such as hydraulic or mechanical in it's light weight, simplicity and reliability. It provides a method to make a fuel powered manned quadcopter safe in the event of engine failure as well as reduces the number of engines required. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a” “an”, and “the”, as used in this specification, include plural referents unless the content clearly dictates otherwise.

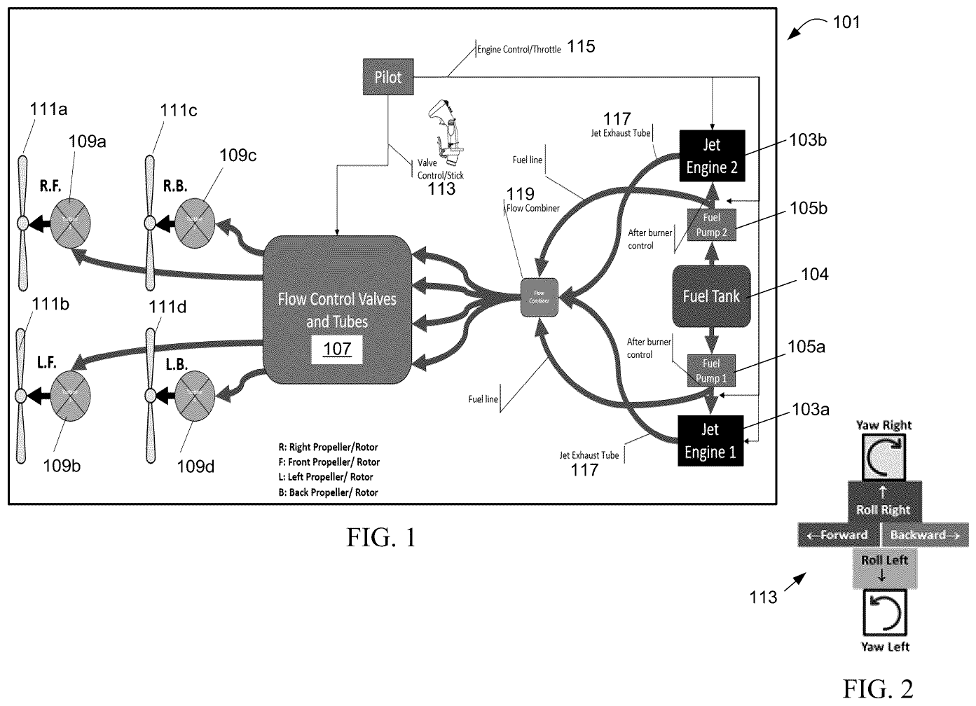

Referring now to FIG. 1 in the drawings, a schematic of a gas turbine multicopter system is provided. System 101 is configured to combine the use of gas powered engines in the control and operation of propellers and rotors in a multicopter configuration. System 101 includes an engine 103a and 103b configured to receive fuel from fuel tank 104 via fuel pumps 105a and 105b. It should be understood that system 101 is operable with one or more engines and one or more fuel tanks. As depicted in FIG. 1, a multiple engine configuration is shown. Exhaust produced from engines 103a and 103b are directed towards flow control valves 107. The flow control valves are operable in response to a pilot's inputs via the control stick 113. Exhaust is provided and regulated through the control valves 107 and supplied to turbines 109a-109d which are then configured to transfer the exhaust into mechanically rotatable propellers/rotors 111a-111d. Turbines 109a-109d receive high energy exhaust gas from engines 103a and 103b and are used to rotate the propellers.

In operation engine control and throttle communications 115 are transmitted to engines and fuel delivery system. The throttle within the aircraft controls the engines. An example of engines 103a and 103b are jet engines as illustrated. It is understood that other types of engines may be utilized but may not always be a better option as compared to jet engines. As noted previously, it is possible that system 101 be operable with a single engine configuration. In the event of a single engine failure there would be no control of the propeller and rotors. A dual engine setup may be advantageous in that it can provide a failsafe setup. In the event a single engine fails, it may only require a backflow preventer within the exhaust tubes to prevent produced exhaust from exiting through the failed engine. The singular producing engine in this situation would be sufficient to provide enough exhaust to operate turbines 109a-109d.

A feature of jet engines is the capacity to have afterburner control. Throttle communications 115 may command afterburner which injects fuel directly into the jet flow lines to provide instant power when needed. This power helps compensate for the power delay associated with jet engine spool up time. Proper regulation and operation of throttle afterburners can create a seamless and smooth generation of power and exhaust output.

Exhaust tubes 117 are coupled to engines 103a and 103b and route the exhaust produced to a flow combiner 119. Flow combiner 119 is necessary to combine jet exhaust from two or more jet engines before passing it to the flow control valves 107. Flow combiner 119 may include the backflow preventer or one way valve in the event of an engine failure to prevent reverse flow to the failed engine. Flow combiner 119 is configured to capture the exhaust and regulate its dispersal evenly to flow control valves 107.

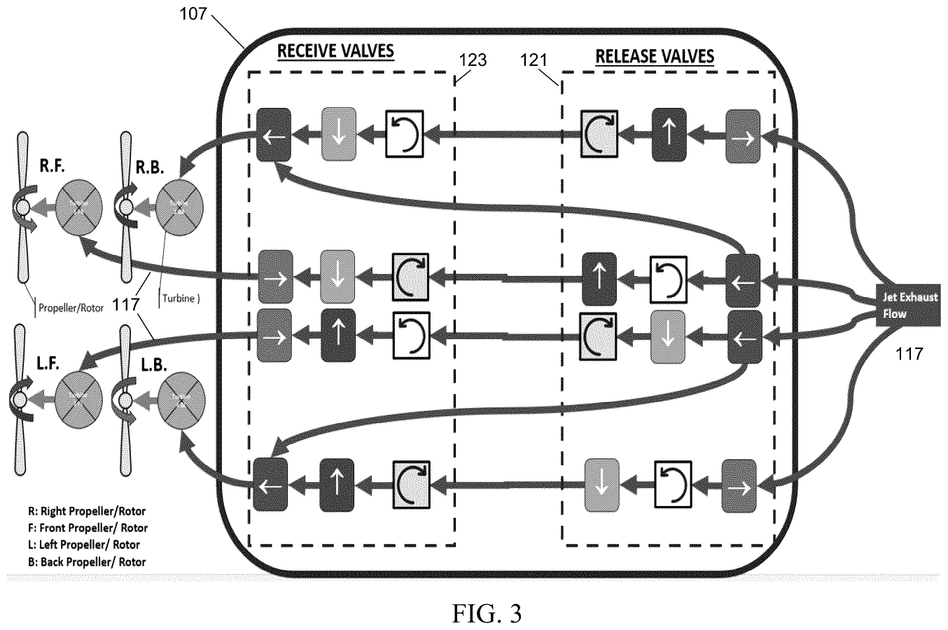

Referring now also to FIG. 2 of the drawings, a chart of throttle controls from control stick 113 is illustrated. FIG. 2 illustrates control inputs that are applied to control stick 113 by a user/pilot. User inputs received from a pilot are communicated to flow control valves 107. It is understood that the associated movements and resultant controls are exemplary and may be modified in other embodiments. Such control inputs from FIG. 2 are represented more clearly in FIGS. 3-8 in terms of how flow control valves 107 are operated within system 101.

Referring now also to FIGS. 3-8 in the drawings, schematics showing the operation of flow control valves 107 are illustrated for different control inputs of control stick 113. Flow control valves 107 are configured to distribute the jet exhaust flow or power to the propellers 111a-111d so as to control pitch, roll, and yaw functions. In other words, the flow control valves selectively redirect the flow of exhaust gas to the plurality of turbines to adjust the flight characteristic of the multicopter.

Flow control valves 107 include a set of twelve release valves 121 and twelve receive valves 123. Release valves 121 extract flow or power from the direct flow line of a set of two propellers and sends it to a different flow line of a set of two other propellers, via control tubes. Each degree of freedom consists of four valves, namely 2 release valves 121 and two receive valves 123. The degrees of freedom are 1) forward pitch/nose down, 2) backward pitch/nose up, 3) roll right, 4) roll left, 5) yaw right, and 6) yaw left. Directional arrows, corresponding to the control stick motions in FIG. 2, are illustrated for each valve of the flow control valves 107 as seen in FIGS. 3-8.

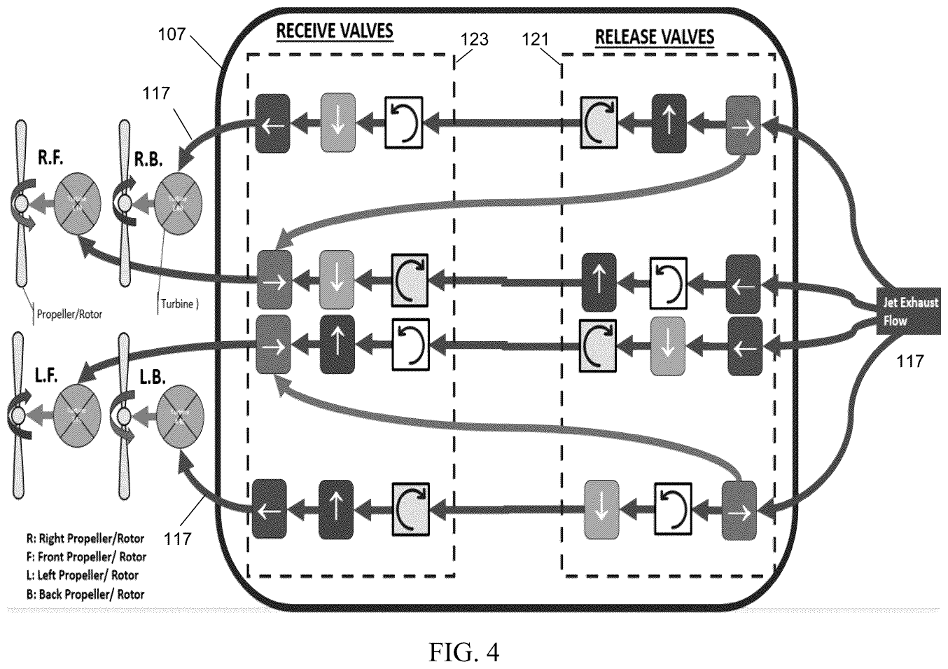

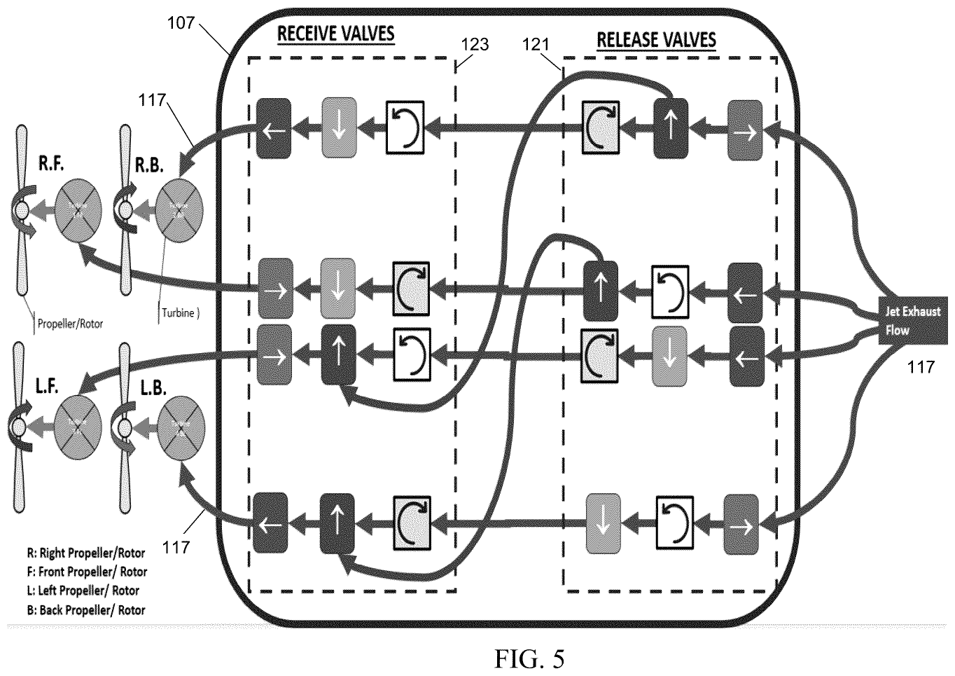

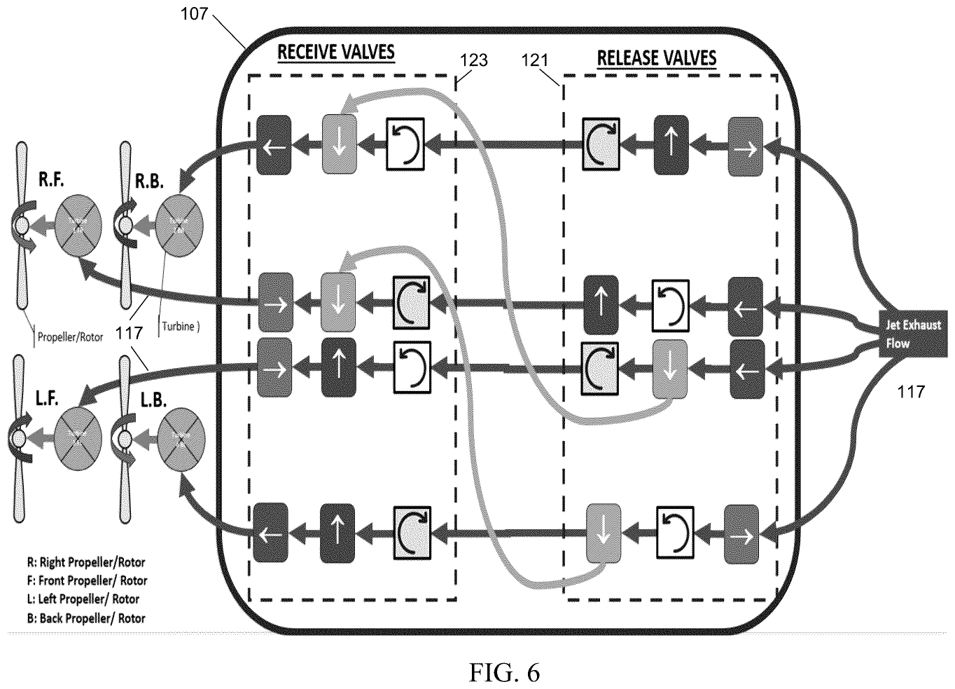

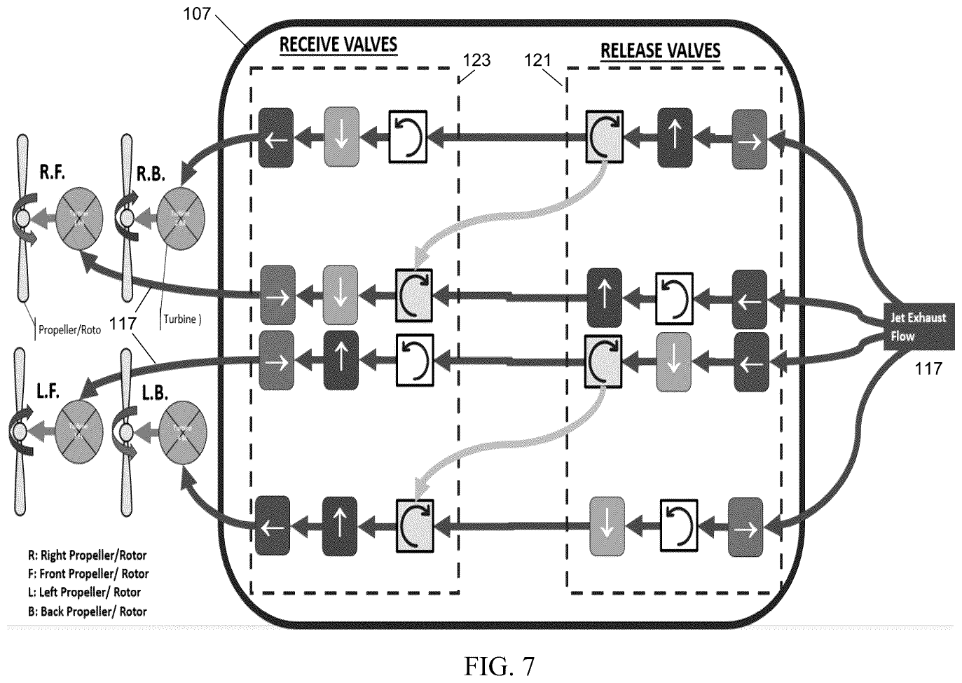

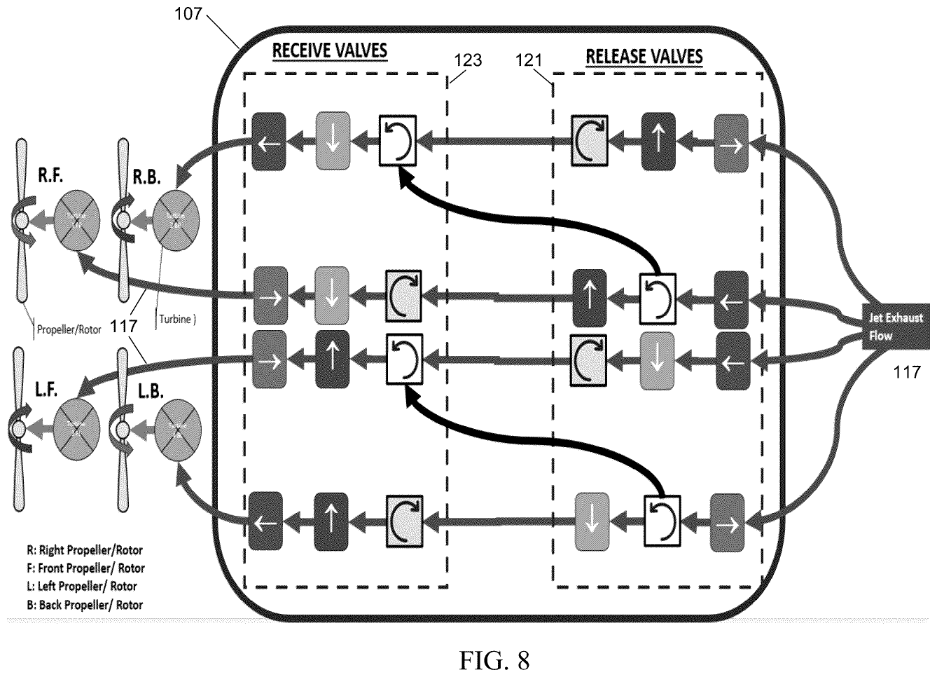

FIGS. 3-8 are illustrative of the different degrees of freedom, or control stick 113 motions a user/pilot may command. With each command from the pilot, different actuation of valves occurs to bring about the resultant command. The schematics of FIGS. 3-8 are useful to illustrate how the flight control system of system 101 and in particular the flow control valves 107 route exhaust gases from the engines to turbines 109a-109d and eventually propellers 111a-111d. For the purpose of clarity, the routing of exhaust between the valves has been separated through the various Figures. In particular, FIG. 3 illustrates forward pitch control. FIG. 4 illustrates backward pitch control. FIG. 5 illustrates right roll control while FIG. 6 illustrates left roll control. FIG. 7 illustrates yaw right control and FIG. 8 illustrates yaw left control.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A gas powered multicopter system, comprising:
a gas powered engine configured to produce exhaust;
an exhaust tube coupled to the gas powered engine and configured to direct the flow of exhaust;
a flow combiner configured to receive the exhaust through the exhaust tube and further configured to regulate downstream flow of exhaust;
a plurality of flow control valves operable through association with the exhaust from the flow combiner;
a plurality of turbines in communication with the exhaust from the plurality of flow control valves, the plurality of turbines configured to convert exhaust from the plurality of flow control valves into rotational power; and
a plurality of rotors in mechanical communication with the plurality of turbines and being configured to rotate and generate lift.

2. The system of claim 1, wherein engine failure of the gas powered engine affects all of the plurality of turbines.

3. The system of claim 1, wherein the flow combiner includes a backflow preventer.

4. The system of claim 1, wherein the plurality of turbines are powered through the use of exhaust.

5. The system of claim 1, wherein the plurality of flow control valves include a set of release valves and a set of receive valves.

6. The system of claim 5, wherein the number of release valves is equal to the number of receive valves.

7. The system of claim 5, wherein the release valves are configured to extract flow from a first rotor of the plurality of rotors and divert it to a receive valve associated with a second rotor of the plurality of rotors.

8. A gas powered multicopter system, comprising:
a gas powered engine configured to produce exhaust;
an exhaust tube coupled to the gas powered engine and configured to direct the flow of exhaust;
a flow combiner configured to receive the exhaust through the exhaust tube and further configured to regulate downstream flow of exhaust;
a plurality of flow control valves operable through association with the exhaust from the flow combiner;
a control stick configured to receive inputs and actuate the plurality of flow control valves;
a plurality of turbines in communication with the exhaust from the plurality of flow control valves, the plurality of turbines configured to convert exhaust from the plurality of flow control valves into rotational power; and
a plurality of rotors in mechanical communication with the plurality of turbines and being configured to rotate and generate lift.

9. The system of claim 8, wherein engine failure of the gas powered engine affects all of the plurality of turbines.

10. The system of claim 8, wherein the flow combiner includes a backflow preventer.

11. The system of claim 8, wherein the plurality of turbines are powered through the use of exhaust.

12. The system of claim 8, wherein the plurality of flow control valves include a set of release valves and a set of receive valves.

13. The system of claim 12, wherein the number of release valves is equal to the number of receive valves.

14. The system of claim 12, wherein two receive valves and two release valves are associated with each input of the control stick.

15. The system of claim 12, wherein each input of the control stick adjusts the flow of exhaust from a portion of the plurality of rotors to a different portion of the plurality of rotors.

16. The system of claim 12, wherein the release valves are configured to extract flow from a first rotor of the plurality of rotors and divert it to a receive valve associated with a second rotor of the plurality of rotors.
